(19) United States
(12) Patent Application Publication
(10) Pub. No.: US 2024/0401977 A1
(43) Pub. Date: Dec. 5, 2024

(54) INFORMATION PROCESSING APPARATUS

(71) Applicant: TOYOTA JIDOSHA KABUSHIKI KAISHA, Aichi-ken (JP)

(72) Inventor: Kyoya NAKAMIKAWA, Kawasaki-shi (JP)

(21) Appl. No.: 18/679,446

(22) Filed: May 31, 2024

(30) Foreign Application Priority Data
Jun. 5, 2023 (JP) 2023-092744

(51) Int. Cl. G01C 22/00

(52) U.S. Cl. CPC G01C 22/006

(57) ABSTRACT

An information processing apparatus includes a communication interface, and a controller configured to acquire, from a terminal apparatus used by a user, a measurement result of a physical activity of the user by the communication interface, and the controller is configured to estimate, in a case in which the measurement result is not acquired, the measurement result when the user traveled from one location to a separate location based on visiting information regarding positions and types of a plurality of locations that the user visited and a time of visit to each location by the user.

### CROSS-REFERENCE TO RELATED APPLICATION

This application claims priority to Japanese Patent Application No. 2023-092744 filed on Jun. 5, 2023, the entire contents of which are incorporated herein by reference.

### TECHNICAL FIELD

The present disclosure relates to an information processing apparatus.

### BACKGROUND

Technology for detecting the number of steps taken by a user using a terminal apparatus having a pedometer function is known. For example, Patent Literature (PTL) 1 discloses technology for estimating the step length and the number of steps based on acceleration detected by a terminal apparatus worn by a user.

### CITATION LIST

### Patent Literature

PTL 1: JP 2014-059315 A

### SUMMARY

There is room for improvement in the degree of certainty of acquiring information regarding a physical activity of a user.

It would be helpful to provide an information processing apparatus or the like that can improve the degree of certainty of acquiring information regarding a physical activity of a user.

An information processing apparatus according to an embodiment of the present disclosure includes:
a communication interface; and
a controller configured to acquire, from a terminal apparatus used by a user, a measurement result of a physical activity of the user by the communication interface,
wherein the controller is configured to estimate, in a case in which the measurement result is not acquired, the measurement result when the user traveled from one location to a separate location based on visiting information regarding positions and types of a plurality of locations that the user visited and a time of visit to each location by the user.

According to an information processing apparatus or the like of the present disclosure, the degree of certainty of acquiring information regarding a physical activity of a user can be improved.

### BRIEF DESCRIPTION OF THE DRAWINGS

In the accompanying drawings:

FIG. 1 is a diagram illustrating a schematic configuration of an information processing system;

FIG. 2 is a flowchart illustrating operations of an information processing apparatus; and

FIG. 3 is a diagram illustrating information to be used for estimating measurement results.

### DETAILED DESCRIPTION

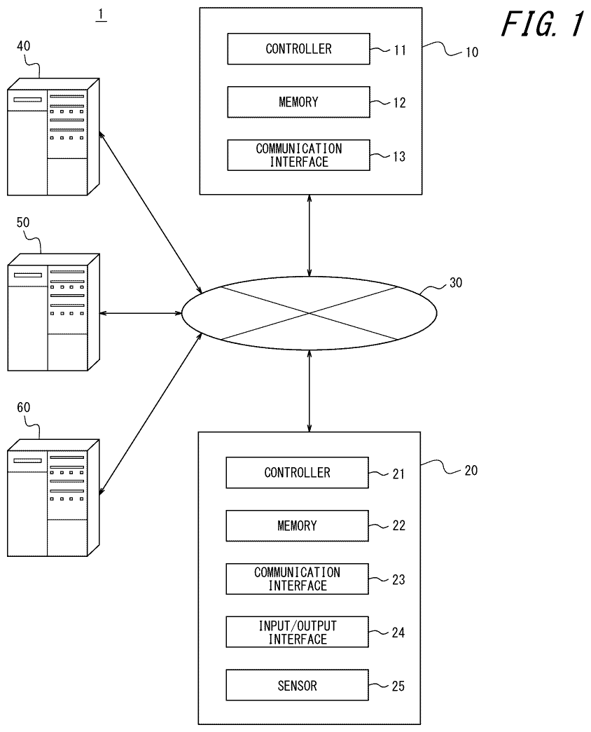

FIG. 1 is a diagram illustrating a configuration example of an information processing system 1 according to the present embodiment. The information processing system 1 includes an information processing apparatus 10, a terminal apparatus 20, a server apparatus 40, a server apparatus 50, and a server apparatus 60. The information processing apparatus 10, the terminal apparatus 20, the server apparatus 40, and the server apparatus 50, and the server apparatus 60 are communicably connected to a network 30 including, for example, the Internet, a mobile communication network, and the like.

The information processing apparatus 10 is a server computer installed in a facility such as a data center. The information processing apparatus 10 is, for example, a server which belongs to a cloud computing system or other computing systems.

The terminal apparatus 20 is, for example, a mobile device held by a user, such as a mobile phone, a smartphone, or a tablet. The terminal apparatus 20 includes wearable terminals. The terminal apparatus 20 has the function of recording the measurement result of the physical activity of the user, for example, a pedometer function and the like. The terminal apparatus 20 has the function of acquiring positional information indicating the position of the terminal apparatus 20 using the network 30.

The network 30 includes the Internet, at least one wide area network (WAN), at least one metropolitan area network (MAN), or a combination thereof. The network 30 may include at least one wireless network, at least one optical network, or a combination thereof. The wireless network is, for example, an ad hoc network, a cellular network, a wireless local area network (LAN), a satellite communication network, or a terrestrial microwave network. The network 30 includes public and dedicated networks.

The server apparatus 40, the server apparatus 50, and the server apparatus 60 are server computers installed in facilities such as data centers. The server apparatus 40, the server apparatus 50, and the server apparatus 60 are, for example, servers that belong to a cloud computing system or another type of computing system.

The information processing system 1 assists a user in acquiring a lifelog of the user. The lifelog is a history of the measurement results of the physical activity of the user. The physical activity is specifically walking, and the measurement result is the number of steps. The lifelog includes walking distance based on the number of steps, calories burned, etc. The lifelog may include sleep time, meal time, etc. as the measurement result during inactivity. The measurement of the physical activity is performed by the terminal apparatus 20 of the user. In the present embodiment, even if the measurement results of the physical activity are not acquired because the user forgot to carry the terminal apparatus 20, etc., the information processing system 1 estimates the measurement results, thus supplementing the lifelog.

The information processing apparatus 10 has a communication interface 13 and a controller 11 that acquires the measurement results of the physical activity of the user from the terminal apparatus 20 used by the user via the communication interface 13. If the measurement results are not acquired, the controller 11 estimates the measurement results when the user traveled from one location to a separate location based on visiting information regarding positions and types of a plurality of locations that the user visited and a time of visit to each location by the user. The number of steps is proportional to the distance traveled, and there is a high probability that the number of steps will not vary significantly according to the type of each location. Therefore, according to the information processing apparatus 10, even if the number of steps has not been acquired because the user forgot to carry the terminal apparatus 20, etc., the number of steps can be estimated using the distance between locations and the measured values that are pre-mapped to the type of each location. Therefore, the degree of certainty of acquiring information regarding the physical activity of the user can be improved.

### <Example Configuration of Information Processing Apparatus 10>

The information processing apparatus 10 includes the controller 11, a memory 12, and the communication interface 13.

The controller 11 includes at least one processor, at least one dedicated circuit, or a combination thereof. Examples of the processor include a general purpose processor such as a central processing unit (CPU) or a graphics processing unit (GPU), or a dedicated processor dedicated to specific processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores any information, control and processing programs, and the like to be used for the operations of the information processing apparatus 10 and information acquired by the operations of the information processing apparatus 10.

The communication interface 13 includes at least one interface for communication. The interface for communication includes, for example, a LAN interface. The interface for communication may include an interface corresponding to mobile communication standards, such as Long Term Evolution (LTE), 4th Generation (4G), or 5th Generation (5G). The communication interface 13 receives data to be used for the operations of the information processing apparatus 10, and transmits data obtained by the operations of the information processing apparatus 10.

### <Example of Configuration of Terminal Apparatus 20>

The terminal apparatus 20 includes a controller 21, a memory 22, a communication interface 23, an input/output interface 24, and a sensor 25.

The controller 21 includes at least one processor, such as a CPU, a Micro Processing Unit (MPU), at least one dedicated circuit, or a combination of these. Examples of the processor include a general purpose processor and a dedicated processor dedicated to specific processing. The dedicated circuit is, for example, an FPGA or an ASIC. The controller 11 executes processes related to operations of the information processing apparatus 10 while controlling components of the information processing apparatus 10.

The memory 22 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 22 functions as, for example, a main memory, an auxiliary memory, or a cache memory. The memory 22 stores any information, control and processing programs, and the like to be used for the operations of the terminal apparatus 20 and information obtained by the operations of the terminal apparatus 20.

The communication interface 23 includes at least one interface for communication. Examples of the interface for communication include an interface corresponding to mobile communication standards, such as a LAN interface, Long Term Evolution (LTE), 4th generation (4G), or 5th generation (5G). The communication interface 23 receives data to be used for the operations of the terminal apparatus 20, and transmits data obtained by the operations of the terminal apparatus 20.

The input/output interface 24 includes at least one interface for input/output. The interface for input/output includes a touch screen integrated with the display. The input/output interface 24 accepts operations for inputting information to be used for the operations of the terminal apparatus 20 and outputs information obtained by the operations of the terminal apparatus 20. The input/output interface 24 may be connected to the terminal apparatus 20 as an external input device, instead of being included in the terminal apparatus 20. As a connection method, for example, any technology such as USB, HDMI® (HDMI is a registered trademark in Japan, other countries, or both), or Bluetooth® can be used. The input/output interface 24 may be composed of separate input and output interfaces without being integrated. In this case, the input interface includes at least one interface for input, such as a physical key, a capacitive key, a pointing device, a microphone, or the like. The output interface includes at least one interface for output, such as a display, a speaker, or the like.

The sensor 25 includes sensors that detect the status of the terminal apparatus 20. The sensors include accelerometers, gyroscopes, etc. The sensor 25 transmits the detected data to the controller 21. The sensor 25 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The sensor 25 transmits the positioning results to the controller 21, and the positional information for the terminal apparatus 20 is obtained by the controller 21.

The controller 21 processes the data detected by the sensor 25, for example, using an arbitrary algorithm to identify the user's walking motion, and stores the number of steps and the time when the measurement of the number of steps has been performed in the memory 22.

### <Example Configuration of Program>

The functions of the information processing apparatus 10 or the terminal apparatus 20 may be implemented by executing a program according to the present embodiment by a processor corresponding to the controller 11 or the controller 21. The program is a program for causing the computer to function as the information processing apparatus 10 or the terminal apparatus 20. The program can be stored in a non-transitory computer readable medium such as a ROM or the like. Examples of the computer readable medium may include a magnetic recording device, an optical disk, and a magneto-optical storage device. The program may be distributed by portable media or over a network from a server or other source. Alternatively, the program may be stored in a server, or the like, and executed through a so-called application service provider (ASP) type service in which the functions are realized by execution of instructions and acquisition of results from the information processing apparatus 10.

<Example Operations of Information Processing Apparatus 10>

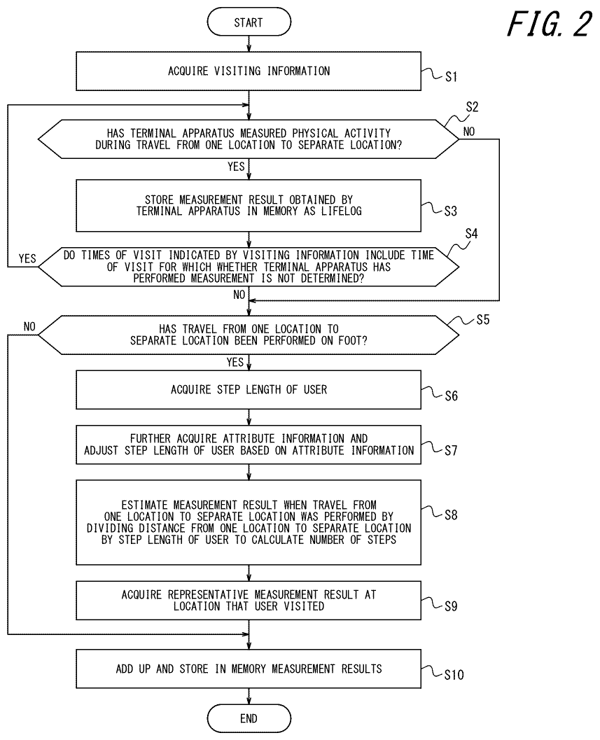

FIG. 2. is a flowchart illustrating an example operation procedure of the information processing apparatus 10. The procedure in FIG. 2 is a procedure pertaining to information processing executed by the controller 11 of the information processing apparatus 10, and is executed in cycles of several seconds to several tens of seconds, for example.

In step S1, the controller 11 acquires visiting information for each user. The visiting information is information regarding positions and types of a plurality of locations that each user visited and the time of visit to each location. The controller 11 acquires the positions of a plurality of locations that each user visited and the time of visit by any method, and determines the type of location corresponding to the position of the location using the map information. For example, the controller 11 acquires information on the position of each facility and the admission time of each user, i.e., the time of visit, from the server apparatus 40 that maintains admission records for any given facility. At each facility, for example, the entrance gate detects the user's visit by reading the user's ID card, etc., or by biometric authentication. For example, the controller 11 may acquire information on the position of the camera, the captured image, and the time of the capture from a camera installed at an arbitrary location, recognize the user's visit from the captured image, and determine the time of visit. Furthermore, for example, the controller 11 may acquire information on the position of the location where the settlement was made and settlement time from the server apparatus 50 that manages a history of the settlement of each user's credit card, etc., and use the settlement time as the time of visit. The visiting information may further include the time spent at each location. In this case, the difference between the time of entry and the time of exit of the user indicated by the entry/exit history information is included as the time spent. For example, the controller 11 acquires map information from the server apparatus 60 of a business that provides map information. The types of locations include retail stores, athletic facilities, and public facilities. The retail stores include supermarkets, department stores, convenience stores, shopping malls, etc. The exercise facilities include gyms, swimming pools, etc. The public facilities include stations, schools, libraries, etc. The type of location may be pre-set by the user and stored in the memory 12.

In step S2, the controller 11 determines whether the terminal apparatus 20 held by the user has performed measurement of the physical activity, or walking, of each user while traveling from one location to a separate location. If the controller 11 acquired the measurement results between one time of visit and a separate time of visit, it determines that the terminal apparatus 20 has performed measurement of walking. If it could not be acquired, the controller 11 determines that the terminal apparatus 20 has not performed measurement of walking. If it is determined that the measurement of walking has been performed, the operation of the controller 11 process proceeds to step S3. If it is determined that no measurement of walking has been performed, the operation of the controller 11 process proceeds to step S5.

In step S3, the controller 11 stores the measurement results by the terminal apparatus 20, i.e., the number of steps, in the memory 12 as a lifelog. As illustrated in steps S2 and S3, if the terminal apparatus 20 has performed the measurement of walking, the controller 11 gives priority to adopt the number of steps of which the terminal apparatus 20 has performed measurement as a lifelog.

In step S4, the controller 11 determines whether the times of visit indicated by the visiting information include a time of visit for which whether the terminal apparatus 20 has performed measurement is not determined. In the present embodiment, when the measurement of the lifelog is performed by the terminal apparatus 20, the measurement is assumed to be continuous between the times of visit. If a time of visit for which whether the terminal apparatus 20 has performed measurement is not determined is included, the operation of the controller 11 process returns to step S2. If a time of visit for which whether the terminal apparatus 20 has performed measurement is not determined is not included, the operation of the controller 11 process proceeds to step S5.

In step S5, the controller 11 determines whether the user has traveled from one location to a separate location on foot. The controller 11 determines whether the distance between the visited sites divided by the difference in the times of visit, i.e., the speed at which the user is traveling, is less than a predetermined value. The distance from one location to a separate location is specifically the distance of a walkable route on a map. The controller 11 may acquire the distance of the route based on the positional information included in the visiting information and based on the map information acquired from the server apparatus 60 of the operator providing the map information. If there are multiple routes, the controller 11 may calculate and acquire the average distance of the multiple routes. The controller 11 determines that the user has traveled between locations on foot if the speed of the user's travel is less than a predetermined value, and if the speed is greater than a predetermined value, the user has not traveled between locations on foot because the probability that some means of transportation was used is great. If the visiting information includes a plurality of locations, the controller 11 determines whether the user traveled on foot between all locations. The predetermined value is set arbitrarily in advance and stored in the memory 12. Alternatively, the controller 11 may determine whether the user traveled on foot based on the history of transportation use which is included in the payment history information. In this case, the station, bus stop or the like where the user boarded or alighted from the transportation system is included as a location indicated by the payment history information. The controller 11 determines that the user has not traveled between locations on foot from the station, bus stop, etc. where the user boarded the train to the station, bus stop, etc. where the user alighted, as indicated by the payment history information. In a case in which it is determined that the travel has been performed on foot, the operations of the processing by the controller 11 proceeds to step S6. In a case in which it is determined that the travel has not been performed on foot, the operations of the processing by the controller 11 proceeds to step S10.

If it is determined that the user has walked between locations, in step S6, the controller 11 acquires the step length of the user. The step length is preset and stored in the memory 12. In this example, a value of 70 cm is acquired as the step length.

In step S7, the controller 11 further acquires attribute information and adjusts the step length of the user based on the attribute information. The attribute information is information indicating attributes of the user such as gender, age, height, weight, etc. The controller 11 calculates the step length of the user using an arbitrary function that calculates the step length using the attribute as a variable. The function is stored in the memory 12 in advance. In this example, the controller 11 adjusts the calculated step length “60 cm” by changing the step length “70 cm” acquired in step S5.

In step S8, the controller 11 calculates the number of steps by dividing the distance from one location to a separate location by the step length of the user to estimate the measurement result when traveling from one location to a separate location. The controller 11 acquires the distance of the route from one location to a separate location based on the positional information included in the visiting information and based on the map information acquired from the server apparatus 60 of the entity that provides map information, and derives the number of steps by dividing the distance by the step length.

As shown in steps S7 and S8, the controller 11 can estimate the number of steps taken by the user between locations more accurately by dividing the distance from one location to a separate location by a step length that more closely approximates the user's actual step length.

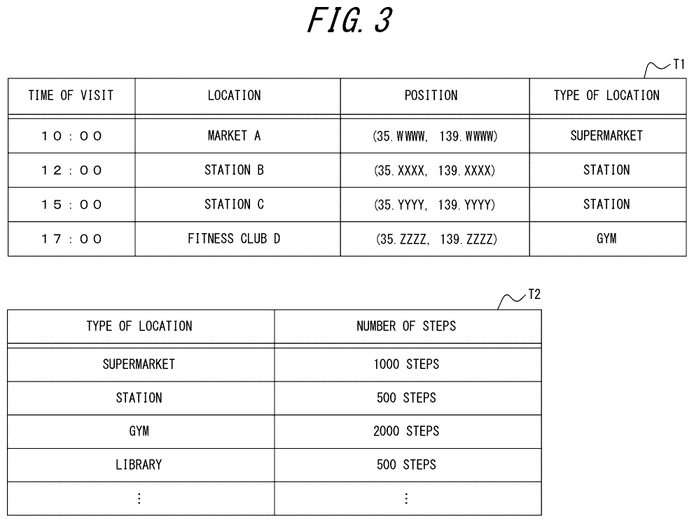

The controller 11 calculates and acquires the number of steps taken by the user between all locations where the user is determined to have traveled on foot. FIG. 3 illustrates the visiting information T1 acquired by the controller 11 in this example. The controller 11 calculates the number of steps taken when the user travels from Market A to Station B and from Station C to D club, which are determined to have been taken on foot, and estimates the measurement results. In this example, the controller 11 calculates the number of steps “2000 steps” calculated by dividing the distance of 1200 m from Market A to Station B by the user's step length of 60 cm, and the number of steps “2500 steps” calculated by dividing the distance of 1500 m from Station C to Fitness Club D by the step length of 60 cm. The controller 11 stores the calculated number of steps in the memory 12.

In step S9, the controller 11 acquires representative measurement results at the location that the user visited. The controller 11 acquires information that records the representative measurement results associated with the type of location. The controller 11 acquires such information from the memory 12 or the terminal apparatus 20 of the user. The representative measurement results are the average number of steps taken by the user in the past at each location included by any type, the latest number of steps, etc. The controller 11 may also estimate the number of steps taken by the user while traveling by recognizing images of the user acquired beforehand from images captured by cameras installed at the facility, and use this as a representative measurement result. In addition, the representative measurement results may be associated with the location itself instead of the type of location. FIG. 3 illustrates information T2, in which the representative measurement results, i.e., the number of steps, are recorded for each type of location. Based on the information T2, the controller 11 acquires lifelogs of the number of steps “1000 steps,” “500 steps,” and “2000 steps” corresponding to the types of locations indicated by the visiting information T1: supermarket, station, and gym, respectively.

If the visiting information includes the time spent at each location, the controller 11 may further read the information in which the measurement results per unit time of the user are recorded for each type of location, and multiply the measurement results by a coefficient corresponding to the time spent to derive a representative measurement result. For example, if the user's lifelog “500 steps” per unit of time corresponding to the type “library” is recorded in the information and the visiting information indicates that the time spent by the user at the location of the type “library” is 2 hours, the controller 11 multiplies 500 steps by a factor of 2.0 corresponding to 2 hours to calculate the number of steps “1000 steps”.

In step S10, the controller 11 stores the value added up the measurement results determined by the terminal apparatus 20 in step S2, the measurement results estimated in step S8, and the measurement results acquired in step S9 in the memory 12.

In this example, the controller 11 adds up the 2000 and 2500 steps estimated in step S8 and the 1000, 500, and 2000 steps acquired in step S9, and stores the total number of steps “8000 steps” in the memory 12. The controller 11 may transmit the total number of steps to the terminal apparatus 20 of the user. Thereafter, the operations by the controller 11 end.

The controller 11 may further calculate the calories consumed by the user using the total number of steps acquired in step S10 and store them in the memory 12 as a lifelog. The controller 11 may use any function stored in advance in the memory 12 for calculation, using the number of steps and the user's weight, height, etc. as variables. The controller 11 may calculate calories based on attribute information of the user acquired in step S7. The controller 11 may calculate the user's total distance traveled by multiplying the total number of steps acquired in step S10 by the step length of the user and store it in the memory 12 as a lifelog.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

1. An information processing apparatus comprising:
a communication interface; and
a controller configured to acquire, from a terminal apparatus used by a user, a measurement result of a physical activity of the user by the communication interface,
wherein the controller is configured to estimate, in a case in which the measurement result is not acquired, the measurement result when the user traveled from one location to a separate location based on visiting information regarding positions and types of a plurality of locations that the user visited and a time of visit to each location by the user.

2. The information processing apparatus according to claim 1, wherein
the physical activity is walking,
the measurement result is a number of steps, and
the controller is configured to estimate the measurement result based on a distance from the one location to the separate location and a number of steps corresponding to each of the types.

3. The information processing apparatus according to claim 2, wherein the controller is configured to divide the distance by a step length of the user to derive a number of steps corresponding to the distance.

4. The information processing apparatus according to claim 3, wherein the controller is configured to adjust the step length of the user according to one or more attributes of the user.

5. The information processing apparatus according to claim 1, wherein the controller is configured to record a lifelog based on a history of the acquired or estimated measurement result.
